(19) United States
(12) Patent Application Publication
(10) Pub. No.: US 2005/0141394 A1
(43) Pub. Date: Jun. 30, 2005

(54) Optical disk drive and information recording method

(75) Inventor: Mitsuo Yamazaki, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 10/938,923

(22) Filed: Sep. 13, 2004

(30) Foreign Application Priority Data
Dec. 26, 2003 (JP) 2003-433933

(51) Int. Cl. G11B 7/00

(52) U.S. Cl. 369/116; 369/53.26

(57) ABSTRACT

An optical disk drive of the present invention has a controller, which obtains saturation levels of a first reflected laser beam obtained by a laser beam with a playback light intensity and a second reflected laser beam obtained by a laser beam with a recording light intensity, in a signal processing circuit, based on the results of detecting the first and second reflected laser beams by a detector, computes the intensity of a recording laser beam output from a light source based on the saturation levels of the reflected laser beams specified by a signal processing means, and instructs a laser driving circuit to drive a laser driving signal capable of achieving the intensities of playback and recording laser beams based on the computation results.

### CROSS-REFERENCE TO RELATED APPLICATIONS

This application is based upon and claims the benefit of priority from prior Japanese Patent Application No. 2003-433933, filed Dec. 26, 2003, the entire contents of which are incorporated herein by reference.

### BACKGROUND OF THE INVENTION

1. Field of the Invention

The present invention relates to an optical disk drive which records information on an optical disk using organic dye material as a recording layer, and an information recording method.

2. Description of the Related Art

As an optical disk capable of recording information, a DVD standard DVD-Recordable (DVD-R) optical disk that can be written only once by using organic dye material as a recording layer is well known.

When recording information on a DVD-R optical disk, a recording mark is formed on a thin layer of organic dye material by irradiating a laser beam of given recording power on a recording layer formed with a thin layer of organic dye material.

However, a thin layer of organic dye material is not necessarily formed with the same thickness in all areas of the recording surface of the optical disk because of the variety of manufacturing methods. It is well known that a preferable recording power differs according to kinds of organic dye material. It is also well know that even if the thickness of organic dye material is substantially even over all areas of the recording surface of an optical disk, the recording power acting on the recording surface becomes uneven because of deflection of the recording surface (sway of the recording surface of an optical disk) caused by rotating the disk at a given speed in an optical disk drive.

As described above, if the recording power does not satisfy given conditions because of the characteristics of organic dye material of an optical disk or the conditions upon recording with an optical disk drive, the shape of a recorded mark may be disturbed and specified performance may not be obtained.

CD-R/RW Technology, Triceps, pp. 78-79, proposes a method of controlling recording power during recording, which is called running OPC (hereinafter referred as R-OPC). In R-OPC, the level of return light during recording a long mark (11T) on an optical disk is detected by a detector, and the recording state is judged by the ratio of the levels of return light at the distal end and terminal end.

Jpn. Pat. Appln. KOKAI Publication No. 2002-358641 proposes a method of estimating the size of a first pulse signal corresponding to a first mark from a space interval signal value corresponding to a space interval of reflected light information signal, by recording the mark and space by a pulse-train-shaped laser output during recording data.

In the method called R-OPC described in the CD-R/RW Technology, Triceps, the ratio of levels at the distal end and terminal end of the return light is low when the recording power is small compared with the state that the recording mark is formed optimally, and the ratio is high when the recording power is large.

However, even the method disclosed in the above literature (Triceps) cannot deal with the level fluctuation caused by variations in the reflectivity of organic reflection material of an optical disk and in the wavelength of a recording laser beam.

The DVD-R optical disks becoming widespread now may use a recording power 30 times larger than the power for playing in order to increase recording speed. Since a detector to detect return light may be saturated in this case, a limiter is used for recording. As a result of using a limiter, however, it becomes substantially difficult to obtain the ratio of levels at the distal end and terminal end of the return light. Further, the R-OPC method has a problem that recording power is not optimized.

The method described in Jpn. Pat. Appln. KOKAI Publication No. 2002-358641 forms at least two recording marks by using a pulse-train-shaped laser output, and estimates laser output corresponding to a first recording mark from a signal corresponding to reflected light from the space interval area between the recording marks. This method has a problem that a laser output is difficult to control.

### BRIEF SUMMARY OF THE INVENTION

According to an aspect of the present invention, there is provided an optical disk drive comprising: a light source which can output a first laser beam with a first light intensity and a second laser beam with a light intensity larger than the first intensity; a first detecting means which detects the light intensities of laser beams condensed and irradiated on a recording layer of a recording medium; a monitoring means which monitors changes in the laser beams based on the output of the first detecting means; a laser power setting means which sets the intensities of the laser beams based on the output of the monitoring means; a laser driving means which supplies the light source with the driving signals corresponding to the first and second laser beams, and gives a modulation component to the second laser beam corresponding to the information to be recorded on a recording medium; a second detecting means which detects first and second reflected laser beams obtained by reflecting the first and second laser beams on a recording layer of a recording medium, and outputs electrical signals corresponding to the intensities of the reflected laser beams; a signal processing means which specifies the saturation levels of the reflected laser beams based on the results of detecting the first and second reflected laser beams by the second detecting means; a computing means which computes the intensity of the second laser beam output from at least the light source, based on the saturation levels of the first and second reflected laser beams specified by the signal processing means; and a controlling means which instructs the laser driving means to drive a laser driving signal capable of achieving the intensities of the first and second laser beams preset based on the results computed by the computing means, together with a driving signal supplied to the laser driving means by the laser power setting means.

According to another aspect of the present invention, there is provided a method of recording information comprising: supplying a light source with a first driving signal corresponding to a first laser beam with a first light intensity and a second driving signal corresponding to a second laser beam with a light intensity larger than the first light intensity; irradiating the first and second laser beams with the light intensities corresponding to the driving signals, on a recording layer of a recording medium; receiving the return lights of the first and second laser beams from a recording layer of a recording medium by a detector, and specifying the saturation levels of reflected laser beams based on the electrical signals corresponding to the light intensities of the received return lights; computing a light intensity of at least second laser beam based on the specified saturation levels of the first and second reflected laser beams; and supplying a light source with a laser driving signal capable of achieving the computed light intensity of the second laser beam.

According to still another aspect of the present invention, there is provided a method of recording information comprising: supplying a light source with a first driving signal corresponding to a first laser beam with a first light intensity and a second driving signal corresponding to a second laser beam with a light intensity larger than the first light intensity; irradiating the first and second laser beams with the light intensities corresponding to the driving signals, on a recording layer of a recording medium; receiving the return lights of the first and second laser beams from a recording layer of a recording medium by a detector, and specifying the saturation levels of reflected laser beams based on the electrical signals corresponding to the light intensities of the received return lights; computing a light intensity of at least the second laser beam based on the specified saturation levels of the first and second reflected laser beams; and setting one of the following to achieve the computed light intensity of the second laser beam: supplying a laser driving signal larger than a current laser driving signal; supplying a laser driving signal smaller than a current laser driving signal; and maintaining the magnitude of a current laser driving signal.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic diagram explaining of a configuration of a pickup and essential parts of an optical disk recording/playback apparatus according to embodiments of this invention;

FIGS. 2A and 2B are graphs explaining the relationship between the monitoring light detected by a monitor detector and the output of a laser driving circuit corresponding to the intensity of a recording laser beam irradiated on a recording layer of an optical disk;

FIGS. 3A and 3B are graphs explaining the relationship between the monitoring light detected by a monitor detector and the output of a laser driving circuit corresponding to the intensity of a recording laser beam irradiated on a recording layer of an optical disk;

FIG. 4 is a graph explaining the relationship between the monitoring light detected by a monitor detector and the output of a laser driving circuit corresponding to the intensity of a recording laser beam irradiated on a recording layer of an optical disk;

FIG. 5 is a graph explaining the relationship among the changes in the reflectivity of a recording layer of an optical disk, the output of a laser driving circuit corresponding to the intensity of a recording laser beam, and the monitoring light detected by a monitor detector; and

FIG. 6 is a flowchart explaining an example of a process for correcting a recording power, so that the level of return light by a recording power achieves a given value, by relating the intensity of a recording laser beam irradiated on a recording layer of an optical disk to the reflectivity change rate, after obtaining the reflectivity change rate of a recording layer of an optical disk by using the return light level by the reading power.

### DETAILED DESCRIPTION OF THE INVENTION

Hereinafter embodiments of the present invention will be explained in detail with reference to the accompanying drawings.

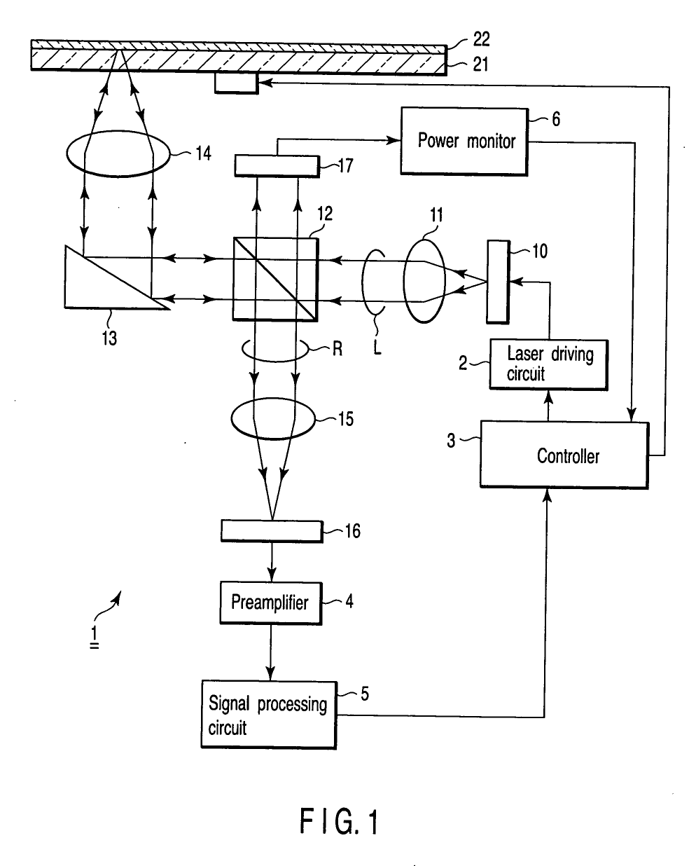

FIG. 1 is a schematic block diagram explaining a configuration of a pickup and essential parts of an optical disk drive (optical disk recording/playback apparatus) according to embodiments of this invention.

In an optical disk drive 1 shown in FIG. 1, information is recorded and reproduced by condensing a laser beam from a laser diode 10 on a recording layer 22 of a DVD-R optical disk 21, for example.

A laser driving circuit 2 controls the laser diode 10 driving current and the laser output volume (laser power) of the laser diode 10. The laser driving circuit switches a laser driving current according to a recording signal, and forms a recording pulse waveform corresponding to information to record.

A laser beam L from the laser diode 10 is collimated by a collimator lens 11, and divided into two luminous fluxes by a beam splitter 12.

One of the luminous fluxes divided by the beam splitter 12 is guided to a recording layer 22 of an optical disk 21. The luminous flux guided from the beam splitter 12 to the recording layer 22 of the optical disk 21 is changed in the optical path direction to be orthogonal to the recording layer 22 of the optical disk 21 through a prism (optical path changing prism) 13, for example, and condensed on the recording layer 22 of the optical disk 21 through an objective 14.

The luminous flux condensed through the objective 14 is transmitted through the board of the optical disk 21, and focused on the recording layer 22. At this time, information is recorded on the recording layer 22 of the optical disk 21, or the information recorded on the recording layer 22 is reproduced.

The reflected light (reflected laser beam) R from the recording layer 22 is transmitted through the objective 14, changed in the direction through the prism 13, and returned to the beam splitter 12.

The reflected laser beam from the recording layer 22 of the optical disk 21 returned to the beam splitter 12 is separated from the light from the light source or the laser diode 10, and the image is formed on the light-receiving surface of a first (playback signal) detector 16 through an image-forming lens 15.

After the image is formed in the detector 16, the return light (reflected laser beam) from the recording layer 22 of the optical disk 21 is converted into a current corresponding to the light intensity by the detector 16. The current is applied to a preamplifier 4 and converted into a voltage, and applied to a signal processing circuit 5.

The signal processing circuit 5 binarizes the voltage signal from the preamplifier 4 at a given threshold level, and demodulates it to digital data.

The digital data demodulated by the signal processing circuit 5 is applied to a controller 3 to be used as a playback signal, or to control the position of the objective 14 (not described in detailed). The data applied to the signal processing circuit 5 is reproduced as the data recorded on the recording layer 22 of the optical disk 21, and output to a playback signal output unit (not shown).

The other laser beam separated by the beam splitter 12 is applied to a second detector 17 for monitoring the intensity of the laser beam L.

Now, explanation will be given on the control of the intensity of a laser beam output from the laser diode 10.

The power of the laser beam L for recording or playback is controlled based on the magnitude of the voltage signal output from the second detector 17.

A monitoring laser beam separated by the beam splitter 12 is converted by the second detector 17 into a current corresponding to the light intensity, and converted by a not-shown amplifier (or an I-V converter) into a-voltage signal.

The voltage signal corresponding to the monitoring laser beam intensity is applied to a power monitoring circuit 6, and detected as the intensity (or the fluctuation of intensity) of the laser beam L output from the laser diode 10.

Next, explanation will be given on the relationship between the intensity of the recording laser beam (the output of the laser driving circuit 2) irradiated to the recording layer 22 of the optical disk 21 and the monitoring light detected by the second detector 17.

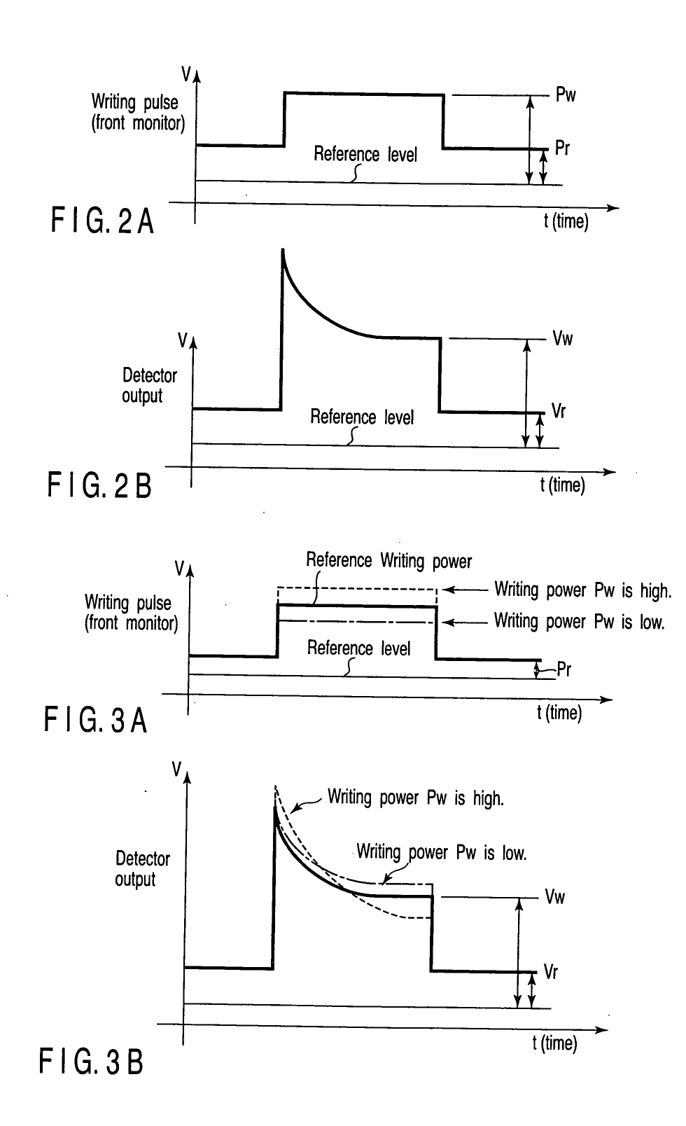

FIG. 2A shows an example of the laser driving pulse applied to the laser diode 10. FIG. 2B shows the voltage-converted output of the detector 16 obtained by detecting the return light intensity of the laser beam outputted from the laser diode 10 corresponding to the laser driving pulse waveform shown in FIG. 2A when it is reflected from the recording layer 22 of the optical disk 21. In FIGS. 2A and 2B, the arrow indicates the time axis, and the vertical axis indicates the voltage values.

As seen from FIG. 2A, a rectangular laser beam is used for recording information in DVD-R, and the output laser beam (not shown) corresponds to the rectangular waveform. In FIGS. 2A and 2B, the laser beam intensity corresponds to the recording power Pw and playback power Pr. In FIG. 2B, the output Vr corresponds to the return light of the playback laser beam with the power Pr reflected from the recording layer 22 of the optical disk 21, and the output Vw corresponds to the return light of the recording laser beam with the power Pw reflected from the recording layer 22 of the optical disk 21.

As seen from FIG. 2B, immediately after a laser beam is irradiated on the recording layer 22 of the optical disk 21, the recording layer 22 changes a little and the reflectivity is large, and a large output can be obtained. As time passes (as an integrated value of the irradiated laser beam increases), a recording mark is rapidly formed and the reflectivity is lowered. Since the decrease of the return light amount caused by the lowered reflectivity is saturated after a while, the output of the detector 16 becomes substantially constant at an optional level Vw. The amount of return light from an optical disk corresponding to a laser beam with the playback power Pr is substantially constant, and the output of the detector 16 becomes substantially constant at an optional level Vr.

FIGS. 3A and 3B explain in detail the relationship between the laser beam intensity and the detector output corresponding to the return light from the recording layer of the optical disk shown in FIGS. 2A and 2B.

As shown in FIG. 3A, a recording mark is formed by a reference recording power indicated by a solid line. The output of the detector 16 corresponding to the amount of a return light from the recording layer 22 of the optical disk 21 shows the change in reflectivity indicated by a solid line. When the recording power indicated by a dotted line is larger than the reference power, the recording mark is formed. In the output of the detector 16 corresponding to the amount of a return light reflected from the recording layer 22 of the optical disk 21, the reflectivity is suddenly lowered almost simultaneously with the start of laser beam irradiation, as indicated by a dotted line in FIG. 3. The level Vwh at which the reflectivity decrease is saturated becomes lower than the level Vwn at which the reflectivity is lowered and saturated by the reference recording power.

Conversely, a recording mark is formed when the recording power is smaller than the reference power as indicated by a chain line in FIGS. 3A and 3B. The output of the detector 16 corresponding to the amount of return light reflected from the recording layer 22 of the optical disk 21 is lowered in the reflectivity almost simultaneously with the start of laser beam irradiation. The level Vwl at which the reflectivity decrease is saturated becomes higher than the level Vwn at which the reflectivity is lowered and saturated by the reference recording power.

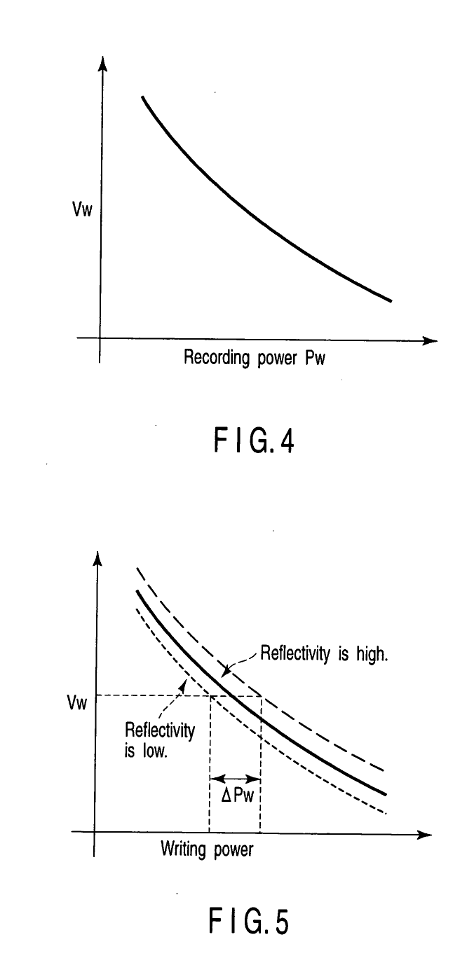

FIG. 4 shows the relationship between the recording power Pw and the change in the Vw value, or the output of the detector 16 corresponding to the intensity of the return light from the recording layer 22 of the optical disk 21.

As seen from FIG. 4, as the recording power Pw increases, the reflectivity drop rapidly advances and the return light intensity Vw decreases.

Therefore, it is necessary to control the recording power Pw so that the Vw indicating the return light level becomes substantially constant in various conditions, for keeping the recording integrity, or the recording mark depth and size formed on the recording layer 22 of the optical disk 21, within a given range.

For example, it is necessary to decrease the recording power Pw when the return light level Vw lowers, and increase the recording power Pw when the return light level Vw rises, as shown in FIG. 4.

It is well known that the relationship shown in FIG. 4 hardly changes when the laser beam wavelength changes little and the reflectivity of the recording layer of an optical disk is substantially constant over all areas.

However, if the laser beam wavelength (for recording) fluctuates or the recording conditions change, for example, the reflectivity of the recording layer of an optical disk differs largely in certain areas, the relationship between the recording power Pw and the return light level Vw is changed as shown in FIG. 5.

FIG. 5 shows an example of the changes in the reflectivity of a recording layer of an optical disk.

As seen from FIG. 5, when the reflectivity of the recording layer of an optical disk fluctuates, the return light level Vw includes an error in the corresponding relationship, just like the recording laser beam intensity Pw changes only by ΔPw, and a level shift may occur, even if the laser beam wavelength does not fluctuate and the recording power is substantially constant.

Therefore, as shown in FIG. 5, when the reflectivity of the recording layer of an optical disk fluctuates, for example, the return light level Vw includes a fluctuation equivalent to the fluctuation of ΔPw in the recording power to keep the return light level Vw constant. In this case, recording with an optimum recording power is impossible.

Thus, as explained with reference to FIGS. 3A (and 3B), first obtain the relationship between the level Vr of the return light from the recording layer of an optical disk when a laser beam with a reading power of Pr is irradiated on the optical disk, and the level Vw of the return light from the recording layer of the optical disk when a laser beam with a recording power of Pw is irradiated to the optical disk. Then, obtain the reflectivity change rate of the recording layer of the optical disk by using the reading power Pr preset to the magnitude capable of obtaining the level Vr. Correct the recording power Pw, so that the magnitude of the level Vw comes within a given range by correlating with the reflectivity change rate. Thus, even if the reflectivity of the recording layer of the optical disk fluctuates, the recording power can be controlled within a substantially constant range.

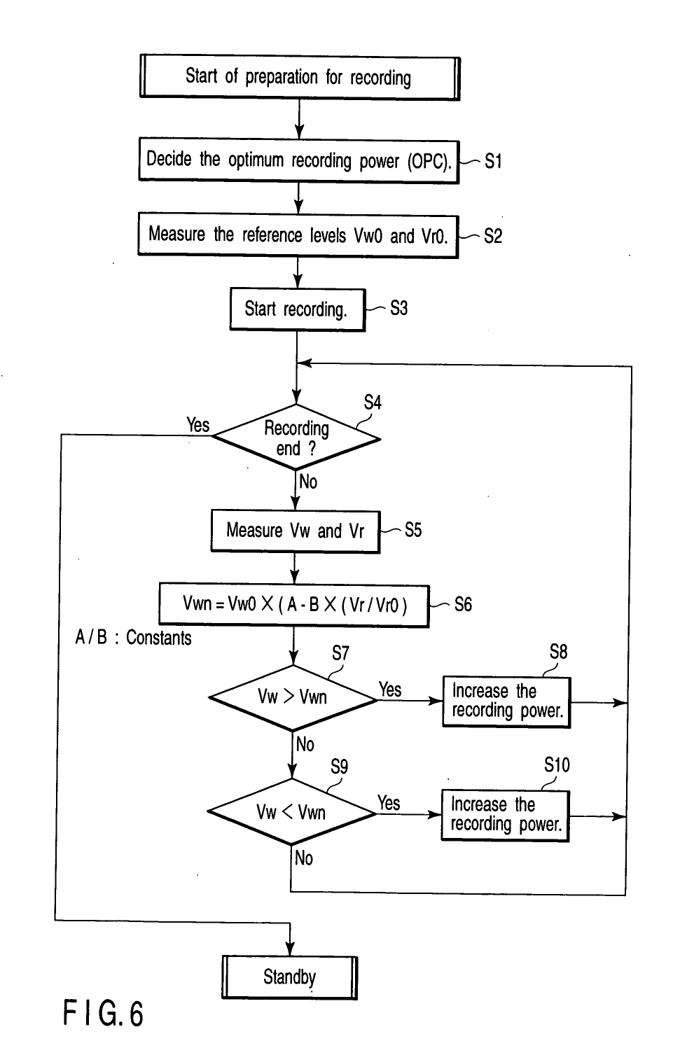

FIG. 6 explains an example of the controlling method.

First, decide an optimum light power to start recording (OPC).

OPC means optimum power control, which decides an optimum light power in a dedicated area provided on the recording layer of an optical disk (S1).

Measure the reference levels Vw₀ and Vr₀ to obtain the change rates of Vw and Vr (S2). The reference levels Vw₀ and Vr₀ can be measured in any optional area of the optical disk, but the same area as OPC (to decide a writing power) is desirable. If the measurement is impossible in the same area as OPC, use an area close to the area used for OPC. Therefore, Vw and Vr with the optimum writing power are measured. As for the reference level detecting position, it is necessary to measure Vw and Vr at the same time.

Next, measure Vw and Vr during actual recording (except after recording [S4-Yes]), at the time when the controller 3 instructs to start recording (S5).

Then, solve the equation (S6):
Vwn=Vw₀×(A−B×(Vr/Vr₀)) [1]
A, B: Constants

Thereafter, substitute the obtained Vwn for Vw by using the equation [1], and control the recording power Pw to make Vwn constant according to the relationship between Pw and Vw explained hereinbefore with reference to FIG. 4. Namely, when the Vw is compared with Vwn and found larger than Vwn (S7-Yes), the recording power is increased (S8).

If Vw is not larger than Vwn in step S7 (S7-No), confirm if Vw is smaller than Vwn (S9).

If Vw is smaller than Vwn in step S9 (S9-Yes), the recording power is decreased (S10).

If Vw is not smaller than Vwn in step S9 (S9-No), Vw=Vwn is specified in addition to the judgment in step S7.

If the end of recording is instructed in step S4 (S4-Yes), the standby state takes place.

If the recording speed is changed by changing the constant A corresponding to the constant B so that Vwn becomes equal to Vw₀ when Vr equals Vr₀ in the equation [1], or if the inclination indicated by the constant B is changed, the optimum recording power adaptable to the recording speed change is set by replacing A by A=B+1.

According to the present invention, as explained above, it is possible to set a laser power to an optimum value for the characteristics of organic dye material at a recording position by controlling a laser power by using return light upon irradiation of a laser beam that indicates the state of recording.

Further, according to the invention, even if the recording laser beam wavelength fluctuates, or the recording conditions change, for example, the reflectivity of a recording layer of an optical disk differs greatly, the recording laser beam power is corrected based on the relationship between the recording power and return light level regardless of the recording speed, recording with an optimum power is possible, and the recording information integrity is improved.

Moreover, according to the invention, the change rate of the reflectivity of the recording layer of an optical disk is obtained by using the return light level of a reading power, based on the relationship between the level of the return light from a recording layer of an optical disk when a laser beam with the reading power is irradiated on the optical disk, and the level of the return light from the recording layer of the optical disk when a laser beam with the recording power is irradiated on the optical disk. Then, the recording power can be controlled within a substantially constant range, even if the reflectivity of the recording layer of the optical disk fluctuates, by correcting the recording power, so that the return light level with of the recording power achieves a given magnitude by correlating with the reflectivity change rate. Namely, an optimum laser power value can be set for the characteristics of the organic dye material at the recording position.

The invention is not limited to the above embodiments. Various modifications may be made without departing from its essential characteristics. Embodiments may be appropriately combined. Effects may be obtained by the combinations.

1. An optical disk drive comprising:
a light source which can output a first laser beam with a first light intensity and a second laser beam with a light intensity larger than the first intensity;
a first detecting means which detects the light intensities of laser beams condensed and irradiated on a recording layer of a recording medium;
a monitoring means which monitors changes in the laser beams based on the output of the first detecting means;
a laser power setting means which sets the intensities of the laser beams based on the output of the monitoring means;
a laser driving means which supplies the light source with the driving signals corresponding to the first and second laser beams, and gives a modulation component to the second laser beam corresponding to the information to be recorded on a recording medium;
a second detecting means which detects first and second reflected laser beams obtained by reflecting the first and second laser beams on a recording layer of a recording medium, and outputs electrical signals corresponding to the intensities of the reflected laser beams;
a signal processing means which specifies the saturation levels of the reflected laser beams based on the results of detecting the first and second reflected laser beams by the second detecting means;
a computing means which computes the intensity of the second laser beam output from at least the light source, based on the saturation levels of the first and second reflected laser beams specified by the signal processing means; and
a controlling means which instructs the laser driving means to drive a laser driving signal capable of achieving the intensities of the first and second laser beams preset based on the results computed by the computing means, together with a driving signal supplied to the laser driving means by the laser power setting means.

2. The optical disk drive according to claim 1, wherein the computing rules of the computing means can be changed according to the speed of recording information in a recording layer of a recording medium.

3. The optical disk drive according to claim 1, wherein when the second detecting means detects the first and second reflected laser beams, reference values for the saturation levels of the reflected laser beams are specified by using the first and second reflected laser beams from optional areas of a recording layer of a recording medium.

4. The optical disk drive according to claim 1, wherein the light intensity of the second laser beam is set by an equation
Vwn=Vw₀×(A−B×(Vr/Vr₀))
Where, A and B are constants;
Vwn is the detection value corresponding to the intensity of the second laser beam;
Vw₀ is a reference value for the detection value for the intensity of the second laser beam;
Vr is the detection value corresponding to the optimum intensity value of the first laser beam; and
Vr₀ is the reference value for the detection value corresponding to the intensity of the first laser beam.

5. The optical disk drive according to claim 4, wherein the change in the recording speed is input as a change in the constant B.

6. A method of recording information comprising:
supplying a light source with a first driving signal corresponding to a first laser beam with a first light intensity and a second driving signal corresponding to a second laser beam with a light intensity larger than the first light intensity;
irradiating the first and second laser beams with the light intensities corresponding to the driving signals, on a recording layer of a recording medium;
receiving the return lights of the first and second laser beams from a recording layer of a recording medium by a detector, and specifying the saturation levels of reflected laser beams based on the electrical signals corresponding to the light intensities of the received return lights;
computing a light intensity of at least second laser beam based on the specified saturation levels of the first and second reflected laser beams; and
supplying a light source with a laser driving signal capable of achieving the computed light intensity of the second laser beam.

7. The method of recording information according to claim 6, wherein the computing rules are changeable according to the speed of recording information on a recording layer of a recording medium.

8. The method of recording information according to claim 7, wherein when the first and second reflected laser beams are detected, reference values for the saturation levels of the reflected laser beams are specified by using the first and second reflected laser beams from optional areas of a recording layer of a recording medium.

9. The method of recording information according to claim 6, wherein the light intensity of a second laser beam is set so that a second level is set within a given range, by obtaining a relationship between a first level or a return light level from a recording layer when a first laser beam is irradiated on a recording layer of a recording medium and a second level or a return light level from a recording layer when a second laser beam is irradiated on a recording layer of a recording medium, obtaining a reflectivity change rate of a recording layer of a recording medium by using a first laser beam whose light intensity is set to be able to obtain a first level, and correlating with the reflectivity change rate.

10. The method of recording information according to claim 7, wherein the light intensity of the second laser beam is set so that a second level is set within a given range, by obtaining a relationship between a first level or a return light level from a recording layer when a first laser beam is irradiated on a recording layer of a recording medium and a second level or a return light level from a recording layer when a second laser beam is irradiated on a recording layer of a recording medium, obtaining a reflectivity change rate of a recording layer of a recording medium by using a first laser beam whose light intensity is set to be able to obtain a first level, and correlating with the reflectivity change rate.

11. The method of recording information according to claim 8, wherein the light intensity of the second laser beam is set so that a second level is set within a given range, by obtaining a relationship between a first level or a return light level from a recording layer when a first laser beam is irradiated on a recording layer of a recording medium and a second level or a return light level from a recording layer when a second laser beam is irradiated on a recording layer of a recording medium, obtaining a reflectivity change rate of a recording layer of a recording medium by using a first laser beam whose light intensity is set to able to obtain a first level, and correlating with the reflectivity change rate.

12. The method of recording information according to claim 6, wherein the light intensity of a second laser beam is set by an equation
Vwn=Vw₀×(A−B×(Vr/Vr₀))
Where, A and B are constants;
Vwn is the detection value corresponding to the intensity of the second laser beam;
Vw₀ is a reference value for the detection value for the intensity of the second laser beam;
Vr is the detection value corresponding to the optimum intensity value of the first laser beam; and
Vr₀ is the reference value for the detection value corresponding to the intensity of the first laser beam.

13. The method of recording information according to claim 12, wherein the recording speed change is input as a change in the constant B.

14. The method of recording information according to claim 7, wherein the light intensity of a second laser beam is set by an equation
Vwn=Vw₀×(A−B×(Vr/Vr₀))
Where, A and B are constants;
Vwn is the detection value corresponding to the intensity of the second laser beam;
Vw₀ is a reference value for the detection value for the intensity of the second laser beam;
Vr is the detection value corresponding to the optimum intensity value of the first laser beam; and
Vr₀ is the reference value for the detection value corresponding to the intensity of the first laser beam.

15. The method of recording information according to claim 14, wherein the recording speed change is input as a change in the constant B.

16. The method of recording information according to claim 8, wherein the light intensity of a second laser beam is set by an equation
Vwn=Vw₀×(A−B×(Vr/Vr₀))
Where, A and B are constants;
Vwn is the detection value corresponding to the intensity of the second laser beam;
Vw₀ is a reference value for the detection value for the intensity of the second laser beam;
Vr is the detection value corresponding to the optimum intensity value of the first laser beam; and
Vr₀ is the reference value for the detection value corresponding to the intensity of the first laser beam.

17. The method of recording information according to claim 16, wherein the recording speed change is input as a change in the constant B.

18. A method of recording information comprising:
supplying a light source with a first driving signal corresponding to a first laser beam with a first light intensity and a second driving signal corresponding to a second laser beam with a light intensity larger than the first light intensity;
irradiating the first and second laser beams with the light intensities corresponding to the driving signals, on a recording layer of a recording medium;
receiving the return lights of the first and second laser beams from a recording layer of a recording medium by a detector, and specifying the saturation levels of reflected laser beams based on the electrical signals corresponding to the light intensities of the received return lights;
computing a light intensity of at least the second laser beam based on the specified saturation levels of the first and second reflected laser beams; and
setting one of the following to achieve the computed light intensity of the second laser beam:
supplying a laser driving signal larger than a current laser driving signal;
supplying a laser driving signal smaller than a current laser driving signal; and
maintaining the magnitude of a current laser driving signal.
